(19) United States
(12) Patent Application Publication
(10) Pub. No.: US 2025/0189742 A1
(43) Pub. Date: Jun. 12, 2025

(54) OPTICAL FIBER RIBBON AND SLOT-LESS OPTICAL CABLE

(71) Applicant: SWCC Corporation, Kawasaki-shi (JP)

(72) Inventors: Takeshiro NAGAI, Kawasaki-shi (JP); Yuki OTA, Kawasaki-shi (JP); Kengo TANABE, Kawasaki-shi (JP); Takehiko YAMAMOTO, Kawasaki-shi (JP); Wataru NORO, Kawasaki-shi (JP)

(21) Appl. No.: 18/840,926

(22) PCT Filed: Feb. 7, 2023
(86) PCT No.: PCT/JP2023/004026

§ 371 Date: Aug. 23, 2024

(30) Foreign Application Priority Data
Feb. 24, 2022 (JP) 2022-026840

(51) Int. Cl. G02B 6/44

(52) U.S. Cl. CPC G02B 6/4431

(57) ABSTRACT

The present application discloses an optical fiber ribbon (1) in which a plurality of single-core coated optical fibers (2) are intermittently connected or separated in a length direction and a width direction while the plurality of single-core coated optical fibers (2) are connected to each other in units of one or two cores. In the optical fiber ribbon (1), conditional expressions [1] and [2] are satisfied, where a is the thickness of a cross section of a connection part (4), b is the outside diameter of the cross section of the connection part (4), A is the length of the connection part (4) in the longitudinal direction, and B is the length of a separation part (6) in the longitudinal direction. [1]: 10 mm≤a/b*A≤35 mm. [2]: 40 mm≤B≤125 mm.

### TECHNICAL FIELD

The present invention relates to an optical fiber tape core wire and a slotless optical cable.

### BACKGROUND ART

In recent years, the prevalence of Internet of Things (IoT), the full-scale commercialization of 5G, automatic driving of automobiles, and the like have caused data traffic to increase dramatically, and there has been a global increase in demand for the establishment/construction of a high-speed large-capacity optical fiber communication network that supports the increase in data traffic.

In particular, cables for information communication in Western countries are often installed in ducts buried underground, and are physically constrained by the installation space in the duct. In order to economically realize the construction of a high-speed large-capacity optical fiber communication network in Western countries, there is a strong demand for reducing installation costs by introducing cables with higher optical fiber density than conventional cables while still using existing ducts.

Patent Literature (hereinafter, referred to as PTL) 1 discloses an optical cable including an intermittent connection type optical fiber tape core wire as an example of the high-density optical cable.

In particular, in PTL 1, the length of the joining portion in the longitudinal direction, the length of the overlapping portion between the non-joining portions of different optical fiber core wires in the longitudinal direction, the length of the non-joining portion in the longitudinal direction, and the like are controlled to be constant, thereby preventing a failure from occurring in the case of fusion connection of optical fiber tape core wires while preventing the optical fiber transmission characteristics from deteriorating (see paragraphs 0026 to 0027, the examples, and FIG. 1, and the like).

### CITATION LIST

### Patent Literature

### PTL 1

Japanese Patent No. 6657976

### SUMMARY OF INVENTION

### Technical Problem

In a high-density optical cable, when optical fiber tape core wires are gathered at a high density and cabled in the optical cable, the optical fiber tape core wire is deformed and implemented in a folded manner. In this deformation, the overlap between the joining portions and the twist of the non-joining portion change depending on the length of the non-joining portion in the intermittent structure. It has been found that such a deformation of the optical fiber tape core wire in a cable greatly affect a microbend loss of an optical fiber. The “microbend loss” refers to light loss due to stress such as a slight pressure applied to the optical fiber strand.

On the other hand, when the high-density optical cable is installed, the high-density optical cable is cut to a certain length and the outer cover or the like is removed, and the exposed optical fiber tape core wire is connected to equipment. After such installation, when the optical fiber tape core wire receives a physical impact such as vibration, the optical fiber tape core wire may move and cause an adverse effect such as tension or buckling on the optical fiber. In order to prevent this, a certain level of drawing force is required for the optical fiber tape core wire with respect to the optical cable.

Accordingly, a main object of the present invention is to provide an optical fiber tape core wire capable of reducing a microbend loss and capable of preventing movement (position shift) of the optical fiber tape core wire after a cable installation, and provide a slotless optical cable using the same.

In order to solve the above problem, one aspect of the present invention provides the following:

An optical fiber tape core wire including:
a plurality of single-core coated optical fibers that are intermittently connected to or separated from each other in a longitudinal direction and a width direction of the optical fiber tape core while the plurality of single-core coated optical fibers are connected to each other in units of one or two cores,
in which when
   a is defined as a thickness of a cross-section of a joining portion,
   b is defined as an outer diameter of a cross-section of the joining portion,
   “A” is defined as a length of the joining portion in the longitudinal direction, and
   “B” is defined as a length of a separation portion in the longitudinal direction,
the optical fiber tape core wire satisfies conditional expressions (1) and (2) below:

$$10 mm \leq a / b * A \leq 35 mm \qquad ( 1 )$$

$$40 mm \leq B \leq 125 mm . \qquad ( 2 )$$

Another aspect of the present invention provides the following:

A slotless optical cable including:
the optical fiber tape core wire described above,
a press winding that fixes a plurality of the optical fiber tape core wires,
an outer cover that covers the press winding,
a tension member installed in the outer cover, and
a rip cord for tearing the outer cover, the rip cord being installed in the outer cover.

### Advantageous Effects of Invention

According to the present invention, it is possible to reduce a microbend loss and to prevent movement (position shift) of an optical fiber tape core wire after the installation.

### BRIEF DESCRIPTION OF DRAWINGS

FIG. 1 is a plan view illustrating a schematic configuration of an optical fiber tape core wire;

FIG. 2 is a cross-sectional view of FIG. 1 taken along line X-X;

FIG. 3 is a perspective view illustrating a schematic configuration of a manufacturing apparatus for an optical fiber tape core wire (i.e., apparatus for manufacturing an optical fiber tape core wire);

FIG. 4 is a schematic configuration of a manufacturing apparatus for an optical fiber tape core wire according to a variation;

FIG. 5A is a side view illustrating a schematic configuration of a rotation blade of the separation die according to the variation;

FIG. 5B is a side view illustrating a schematic configuration of a rotation blade of the separation die according to the variation;

FIG. 5C is a side view illustrating a schematic configuration of the rotation blades of the separation die according to the variation;

FIG. 6 is a side view schematically illustrating the rotation of the rotation blades according to the variation; and

FIG. 7 is a cross-sectional view illustrating a schematic configuration of a slotless optical cable.

### DESCRIPTION OF EMBODIMENTS

Hereinafter, an optical fiber tape core wire and a slotless optical cable according to a preferred embodiment in the present invention will be described. In the present specification, with respect to a numerical range indicated by “to,” the lower limit and upper limit are included in the numerical range.

### [Optical Fiber Tape Core Wire]

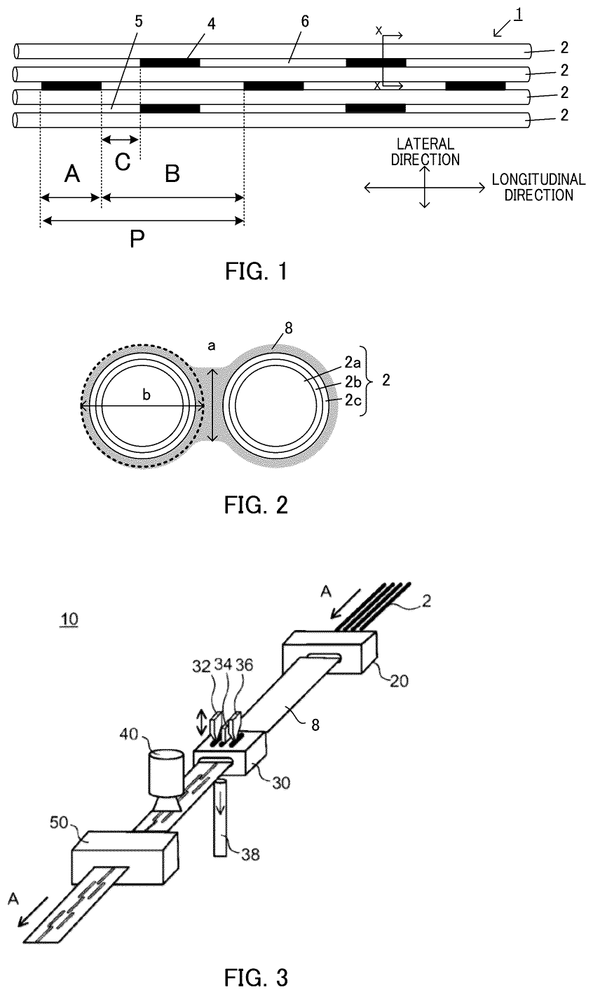

FIG. 1 is a plan view illustrating a schematic configuration of optical fiber tape core wire 1.

As illustrated in FIG. 1, optical fiber tape core wire 1 includes a plurality of single-core coated optical fibers 2 (four fibers in FIG. 1), and adjacent single-core coated optical fibers 2 are intermittently connected to or separated from each other in the longitudinal direction and the width direction thereof, and joining portions 4 and separation portions 6 are disposed in a dispersed manner. Here, a plurality of single-core coated optical fibers 2 are independently connected to each other in units of one core, but may be collectively connected to each other in units of each two cores.

FIG. 2 is a cross-sectional view illustrating a schematic configuration of optical fiber tape core wire 1.

As illustrated in FIG. 2, single-core coated optical fiber 2 has a configuration in which optical fiber strand 2a is coated with primary coating layer 2b and secondary coating layer 2c in this order. Optical fiber tape core wire 1 has a configuration in which single-core coated optical fibers 2 are integrally coated with tape layer 8 (a tape-shaped resin), and joining portion 4 and separation portion 6 are formed relative to tape layer 8.

Tape layer 8 is made of a photocurable resin. The photocurable resin has a viscosity at 25° C. of 4.7 to 8.8 Pa·s, and is preferably an epoxy acrylate-based photocurable resin or a urethane acrylate-based photocurable resin.

As illustrated in FIG. 1, joining portions 4 (single-core coated optical fibers are connected to each other by the joining portion) and separation portions 6 (single-core coated optical fibers are separated from each other by the separation portion) are intermittently formed in optical fiber tape core wire 1. In separation portion 6, non-joining portion 5 is formed in such a way that adjacent separation portions 6 overlap each other when the separation portions are viewed in the width direction.

In such optical fiber tape core wire 1, when a (mm) is defined as the thickness of the cross-section of joining portion 4; b (mm) is defined as the outer diameter of the cross-section of joining portion 4; A (mm) is defined as the length of joining portion 4 in the longitudinal direction of optical fiber tape core wire 1; B (mm) is defined as the length of separation portion 6 in the longitudinal direction; C (mm) is defined as the length, in the longitudinal direction, of non-joining portion 5 (a portion where adjacent separation portions overlap each other when viewed in the width direction); and P (mm) is defined as the periodic interval of joining portion 4 in the longitudinal direction, the following conditional expressions (1) and (2) are satisfied, preferably the following conditional expressions (3) and (4) are satisfied, and more preferably the following conditional expressions (3), (4), (5), and (6) are satisfied.

$$10 mm \leq a / b * A \leq 35 mm \qquad ( 1 )$$

$$40 mm \leq B \leq 125 mm \qquad ( 2 )$$

$$10 mm \leq a / b * A \leq 31 mm \qquad ( 3 )$$

$$40 mm \leq B \leq 100 mm \qquad ( 4 )$$

$$B \geq A and C \geq 10 mm \qquad ( 5 )$$

$$P \leq 150 mm \qquad ( 6 )$$

“Thickness a” of the cross-section of joining portion 4 is the average value of the measured values at five randomly selected sites.

“Outer diameter b” of the cross-section of joining portion 4 is the average value of approximate diameters measured with a microscope manufactured by KEYENCE CORPORATION at five randomly selected sites.

According to optical fiber tape core wire 1 described above, the values of a/b*A and the value of the length B of the separation portion are controlled to be constant, and thus, it is possible to reduce microbend loss and prevent movement (position shift) of optical fiber tape core wire.

### [Manufacturing Apparatus and Method for Manufacturing Optical Fiber Tape Core Wire]

### (1) Manufacturing Apparatus for Optical Fiber Tape Core Wire

FIG. 3 is a schematic configuration of manufacturing apparatus 10 for an optical fiber tape core wire.

As illustrated in FIG. 3, in manufacturing apparatus 10 of optical fiber tape core wire, mainly tape die 20, separation die 30, and two light irradiation apparatuses 40 and 50 are installed in this order along the conveying direction A of single-core coated optical fiber 2, and single-core coated optical fiber 2 passes through these dies and apparatuses in this order.

Tape die 20 is a general-purpose die that coats the peripheries of a plurality of single-core coated optical fibers 2 with a photocurable resin in a batch manner, and is configured to form tape layer 8 by applying the uncured photocurable resin in a tape shape to a plurality of single-core coated optical fibers 2 that pass through tape die 20.

A plurality of separation needles 32, 34, and 36 (three in FIG. 3) vertically movable are installed in separation die 30. Separation needle 32, 34, and 36 are disposed above single-core coated optical fiber 2, and central separation needle 34 and both-side separation needles 32 and 36 are raised and lowered alternately relative to the uncured photocurable resin, thereby forming separation portions 6 and joining portions 4 intermittently.

Resin suction apparatus 38 for suctioning away the excess photocurable resin is installed in separation die 30. Resin suction apparatus 38 is configured to suction the excess photocurable resin dammed by the lowering of separation needles 32, 34, and 36.

Upstream side light irradiation apparatus 40 is configured to irradiate the uncured photocurable resin with light to semi cure the photocurable resin. The term “semi cured” refers to a state in which the resin is not completely cured, that is, a state in which the resin is partially crosslinked with light energy.

Light irradiation apparatus 50 on the downstream side is configured to further irradiate the semi-cured photocurable resin to completely cure the semi-cured resin. The term “completely cured” refers to a state in which the resin is completely or substantially completely cured, that is, a state in which the resin is in a state of being crosslinked to a complete or substantially complete state by light energy.

Regarding upstream side light irradiation apparatus 40 and downstream side light irradiation apparatus 50, upstream side light irradiation apparatus 40 has a small cumulative irradiation amount, and downstream side light irradiation apparatus 50 has a large cumulative irradiation amount.

### (2) Method for Manufacturing Optical Fiber Tape Core Wire

In a state in which a plurality of single-core coated optical fibers 2 are conveyed along the conveying direction A (the conveying speed is preferably 60 to 300 m/min), first, the uncured photocurable resin is applied in a tape shape to the plurality of single-core coated optical fibers 2 with tape die 20 to form tape layer 8.

Subsequently, separation needles 32, 34, and 36 of separation die 30 are raised and lowered with respect to tape layer 8, and separation portions 6 and joining portions 4 are formed relative to tape layer 8.

Subsequently, light irradiation apparatus 40 irradiates tape layer 8 with light to semi cure the uncured photocurable resin, and light irradiation apparatus 50 further irradiates the photocurable resin with light to completely cure the semi-cured photocurable resin. The temperature of tape die 20 is set to be higher than the temperature of separation die 30 during processing of these steps.

### [Variation]

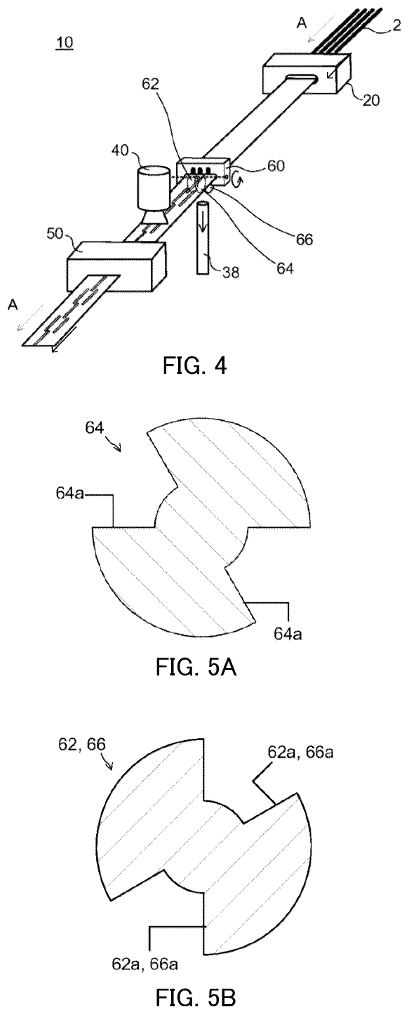

Separation die 60 in FIG. 4 may be applied instead of separation die 30 in FIG. 3. In separation die 60 illustrated in FIG. 4, a plurality of rotation blades 62, 64, and 66 (three blades in FIG. 4) are installed to face the outlet surface of single-core coated optical fiber 2. Each rotation blade 62, 64, 66 rotates to follow the conveyance of the single-core coated optical fibers 2, and the rotation shafts of the blades coincide with each other.

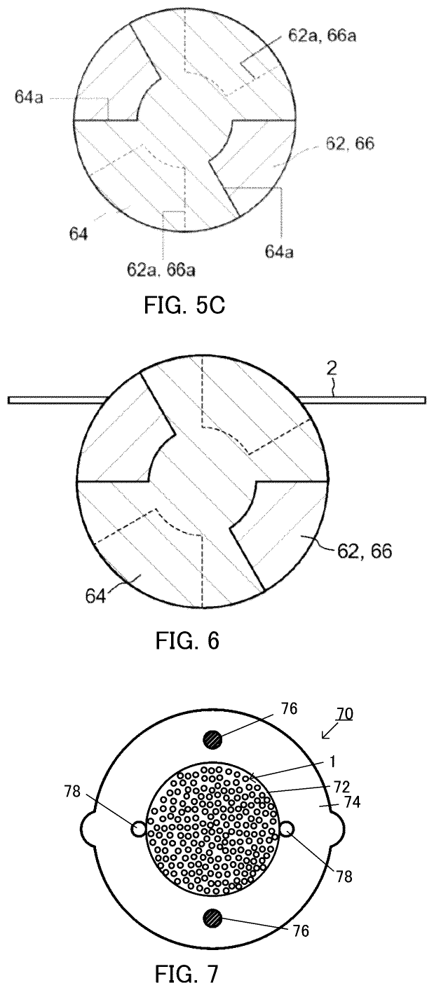

As illustrated in FIG. 5A, notch portions 64a are formed in rotation blade 64 located in the central portion, and as illustrated in FIG. 5B, notch portions 62a and 66a are formed in rotation blades 62 and 66 located in the both side portions. As illustrated in FIG. 5C, the notch portion 64a of rotation blade 64 in the central portion is in a different phase from notch portions 62a and 66a of rotation blades 62 and 66 in the both side portions.

As illustrated in FIG. 6, when rotation blades 62, 64, and 66 rotate while following the conveyance of the single-core coated optical fibers 2, the rotation blades 62, 64, 66 rotate with notch portion 64a of rotation blade 64 in the central portion remaining in a different phase from notch portions 62a and 66a of rotation blades 62 and 66 in the both side portions, thereby alternately forming separation portion 6 and joining portion 4.

### [Slotless Optical Cable]

FIG. 7 is a cross-sectional view illustrating a schematic configuration of slotless optical cable 70 using optical fiber tape core wires 1.

In slotless optical cable 70, a plurality of optical fiber tape core wires 1 are bundled and twisted, and are fixed by press winding 72. For example, five 4-core optical fiber tape core wires 1 are bundled together, ten bundles are twisted, and the twisted body is fixed with press winding 72. Press winding 72 is preferably formed of a water-absorbent nonwoven fabric, and specifically, a nonwoven fabric on which a water-absorbent polymer is adhered may be used.

A polyethylene resin is extruded on press winding 72, and press winding 72 is coated with outer cover 74. One tension member 76 is installed at each of the top and bottom of outer cover 74, and one rip cord 78 for tearing outer cover 74 is also installed on each of the left and right sides of outer cover 74.

According to slotless optical cable 70 described above, tension members 76 are installed at the top and bottom in FIG. 7, and thus, the flexibility in the left-right direction is ensured, and workability when slotless optical cable 70 is laid in the duct can be improved. Since rip cords 78 are also installed at positions symmetrical to each other in the left and right sides (180-degree diagonal) in FIG. 7, it is possible to easily peel outer cover 74 in half and to improve workability when processing a cable terminal or when branching the cable terminal in the middle.

### EXAMPLES

[0025](1) Preparation of sample

### (1.1) Optical Fiber Tape Core Wire Sample

First, an optical fiber having an outer diameter of 250 μm was prepared. In the single-core coated optical fiber, a primary coating formed of a urethane acrylate-based photocurable resin having a Young's modulus at 23° C. of approximately 5 MPa and a secondary coating formed of a urethane acrylate-based photocurable resin having a Young's modulus at 23° C. of approximately 700 MPa are provided on a quartz glass-based SM optical fiber having an outer diameter of 125 μm.

Subsequently, while aligning four single-core coated optical fibers, a urethane acrylate-based photocurable resin (having a viscosity of 5.2±0.5 Pa·s at 25° C. before curing and a Young's modulus of 550 MPa after curing) was applied by using the manufacturing apparatus as in FIG. 3, and samples 1 to 11 of optical fiber tape core wires were manufactured. For the samples 1 to 11 of optical fiber tape core wires, the parameters such as the thickness a of the cross-section of the joining portion, the outer diameter b of the cross-section of the joining portion, the length A of the joining portion in a longitudinal direction, the length B of the separation portion in the longitudinal direction, the length C of the non-joining portion in the longitudinal direction, and the periodic interval P of the joining portion in a longitudinal direction were varied.

### (1.2) Slotless Optical Cable Sample

Samples 1 to 11 of the slotless optical cables as described in FIG. 7 were manufactured by using samples 1 to 11 of the optical fiber tape core wires. Specifically, five samples of a four-core optical fiber tape core wire were prepared, these were bundled with a bundling tape to constitute a 20-core unit. Subsequently, ten 20-core optical units were twisted, fixed with a water-absorbent nonwoven fabric (as press winding). With the tension members and ripcords attached vertically, polyethylene was extruded on the press winding and covered with an outer cover, thereby producing samples 1 to 11 of 200-core slotless optical cables.

### (2) Evaluation of Sample

### (2.1) Measurement of Microbend Loss

In a state in which 12,000 m of the optical fiber tape core wire sample is wound on a bobbin with a winding tension of 300 gf, one end was unwound from the bobbin and connected to an optical time domain reflectmeter (OTDR AQ7280, manufactured by Yokogawa Electric Corporation) via an exciter. The light loss was measured by utilizing a phenomenon in which light incident on an optical fiber returns due to Rayleigh scattering and the like (the measurement wavelength was set to 1,550 nm).

The measurement results are shown in Table 1. In Table 1, “◯” indicates that the measurement value is 0.25 dB/km or less, “Δ” indicates that the measurement value is more than 0.25 dB/km and 0.28 dB/km or less, and “X indicates that the measurement value is more than 0.28 dB/km.

### (2.2) Measurement of Drawing Force

The slotless optical cable sample was cut to 12 m, and 1 m of the outer cover, 1 m of the press winding, 1 m of the tension members, and 1 m of the rip cords were removed from one end (A-end) of the cut piece to expose 1 m of the optical fiber tape core wires. In addition, 1 m of the outer cover, 1 m of the press winding, and 1 m of the rip cords were removed from the other end (B-end) of the cut piece to expose 1 m of the optical fiber tape core wires and the tension members.

Subsequently, all of the optical fiber tape core wires at the A-end were wound around and fixed to the mandrel. Only the tension members at B-end was gripped and fixed with a chuck, and the optical fiber tape core wire at the outer cover side was marked.

Subsequently, the B-end was pulled at 50 mm/min, and the tension when the optical fiber tape core wires at the B-end started to move was used as the drawing force and was measured. The condition for pulling was set to be 360 N/min or less.

The measurement results are shown in Table 1. In Table 1, “◯” indicates that the measurement value is 17 N or more, and “X” indicates that the measurement value is less than 17 N, and the threshold is an index for determining whether there is movement (position shift) of the optical fiber tape core wires or not.

TABLE 1

| Samples | | 1 | 2 | 3 | 4 | 5 | 6 | 7 | 8 | 9 | 10 | 11 |
|---|---|---|---|---|---|---|---|---|---|---|---|---|
| Tape | a/b*A | 8 | 10 | 10 | 16 | 16 | 18 | 28 | 31 | 40 | 35 | 35 |
| structure | a/b | 0.60 | 0.60 | 0.60 | 0.80 | 0.80 | 0.60 | 0.70 | 0.77 | 1.50 | 1.20 | 1.20 |
| | A (mm) | 13 | 17 | 17 | 20 | 20 | 30 | 40 | 40 | 27 | 29 | 29 |
| | B (mm) | 40 | 30 | 40 | 50 | 50 | 50 | 60 | 100 | 35 | 125 | 130 |
| | C (mm) | 13.5 | 6.5 | 11.5 | 15 | 15 | 10 | 10 | 30 | 4 | 48 | 50.5 |
| | P (mm) | 53 | 47 | 57 | 70 | 70 | 80 | 100 | 140 | 62 | 154 | 159 |
| Property | Microbend loss | ◯ | X | ◯ | ◯ | ◯ | ◯ | ◯ | ◯ | X | Δ | ◯ |
| | Drawing force | X | X | ◯ | ◯ | ◯ | ◯ | ◯ | ◯ | ◯ | ◯ | X |

### (3) Summary

As shown in Table 1, the drawing force in Sample 1 was small. This is because the value of a/b*A is small and the occupation rate of the joining portions in the cable inner diameter (inside the press winding) is low.

In samples 2 and 9, the microbend loss was large. This is because the value of length B of the separation portion is small, the appearance frequency of the joining portions per unit length increases, and side pressure loading is more likely to be applied between optical fiber strands that overlap with each other in a state of being wound on a bobbin.

The drawing force was small in sample 11. This is because the separation portion has a large length B and the appearance frequency of the joining portions per unit length decreases.

In contrast, both the results of the microbend loss and the drawing force were satisfactory in samples 3 to 8 and 10. In order to reduce microbend loss and prevent movement (position shift) of the optical fiber tape core wire, it has been found that it is useful to control the values of a/b*A and the length B of the separation portion to be constant.

The present application claims the benefit of priority to Japanese Patent Application No. 2022-026840, filed on Feb. 24, 2022, the entire disclosure of which is incorporated by reference herein. The contents described in the specification and drawings of this application are all incorporated herein by reference.

### INDUSTRIAL APPLICABILITY

The present invention is applied to an optical fiber tape core wire and a slotless optical cable, and is particularly useful for reducing a microbend loss and preventing movement (position shift) of an optical fiber tape core wire after cable installation.

### REFERENCE SIGNS LIST

1 Optical fiber tape core wire
2 Single-core coated optical fiber
4 Joining portion
5 Non-joining portion
6 Separation portion
8 Tape layer
10 Manufacturing apparatus for optical fiber tape core wire
20 Tape die
30 Separation die
32, 34, 36 Separation needle
38 Resin suction apparatus
40 (Upstream side) light irradiation apparatus
50 (Downstream side) light irradiation apparatus
60 Separation die
62, 64, 66 Rotation blade
62a, 64a, 66a Notch portion
70 Slotless optical cable
72 Press winding
74 Outer cover
76 Tension member
78 Rip cord

1. An optical fiber tape core wire comprising:
a plurality of single-core coated optical fibers that are intermittently connected to or separated from each other in a longitudinal direction and a width direction of the optical fiber tape core while the plurality of single-core coated optical fibers are connected to each other in units of one or two cores,
wherein when
a is defined as a thickness of a cross-section of a joining portion,
b is defined as an outer diameter of a cross-section of the joining portion,
“A” is defined as a length of the joining portion in the longitudinal direction, and
“B” is defined as a length of a separation portion in the longitudinal direction,
the optical fiber tape core wire satisfies conditional expressions (1) and (2) below:
$$10 mm \leq a / b * A \leq 35 mm \qquad ( 1 )$$
$$40 mm \leq B \leq 125 mm . \qquad ( 2 )$$

2. The optical fiber tape core wire according to claim 1, wherein
the optical fiber tape core wire satisfies conditional expressions (3) and (4) below:
$$10 mm \leq a / b * A \leq 31 mm \qquad ( 3 )$$
$$40 mm \leq B \leq 100 mm . \qquad ( 4 )$$

3. A slotless optical cable comprising:
the optical fiber tape core wire according to claim 1,
a press winding that fixes a plurality of the optical fiber tape core wires,
an outer cover that covers the press winding,
a tension member installed in the outer cover, and
a rip cord for tearing the outer cover, the rip cord being installed in the outer cover.
